(19) United States
(12) Patent Application Publication
(10) Pub. No.: US 2018/0060441 A1
(43) Pub. Date: Mar. 1, 2018

(54) COMPUTER-READABLE RECORDING MEDIUM, SEARCH METHOD, AND SEARCH APPARATUS

(71) Applicants: FUJITSU LIMITED, Kawasaki-shi (JP); KYUSHU UNIVERSITY, NATIONAL UNIVERSITY CORPORATION, Fukuoka-shi (JP)

(72) Inventors: Yuri NAKAO, Kawasaki (JP); Kotaro Ohori, Sumida (JP); Hiroaki Yoshida, Isehara (JP); Takuya Ohwa, Shinagawa (JP); Akifumi Kira, Fukuoka (JP); Naoyuki Kamiyama, Fukuoka (JP)

(73) Assignees: FUJITSU LIMITED, Kawasaki-shi (JP); KYUSHU UNIVERSITY, NATIONAL UNIVERSITY CORPORATION, Fukuoka-shi (JP)

(21) Appl. No.: 15/683,233

(22) Filed: Aug. 22, 2017

(30) Foreign Application Priority Data
Aug. 23, 2016 (JP) 2016-163096

(51) Int. Cl. G06F 17/30; G06Q 30/02

(52) U.S. Cl. CPC G06F 17/30867; G06Q 30/0203; G06F 17/301

(57) ABSTRACT

A search apparatus specifies a first respondent group based on a respondent attribute of a respondent. The search apparatus searches for a respondent preference of the respondent utilizing a plurality of inquiries for the respondent, the plurality of inquiries being made with a first preference of the first respondent group as an initial value and corresponding to a first segment that the first respondent group belongs to. The search apparatus, when a specific condition is not satisfied after search from the initial value with a specific number of inquiries, generates or selects a second respondents group based on the respondent attribute, answers to the plurality of inquiries, and on preferences of a second respondent group, the second respondent group satisfying the specific condition. The search apparatus searches for the respondent preference with a preference of the second respondent group being an initial value.

### CROSS-REFERENCE TO RELATED APPLICATION

This application is based upon and claims the benefit of priority of the prior Japanese Patent Application No. 2016-163096, filed on Aug. 23, 2016, the entire contents of which are incorporated herein by reference.

### FIELD

The embodiments discussed herein are related to computer-readable recording medium, a search method, and a search apparatus.

### BACKGROUND

Conventionally, a technique has been known, which is for searching preferences of a respondent by: using a Web page and the like; presenting questions to the respondent; and making the respondent answer the questions. For example, in a market survey, according to contents of answers to plural question items asked to a person subjected to the market survey, the person is sorted into any of segments generated beforehand from a large amount of data, and the segment that the person has been sorted into is utilized. Related technologies are described in International Publication Pamphlet No. WO 2006/057356 and Japanese Laid-open Patent Publication No. 2007-115222, for example.

For example, when matching between a person wishing to move to another place and a municipality is performed through use of the above mentioned technique by: questioning being performed for a plural number of times to the person; and preferences, such as points important to the person and likings of the person, being estimated; by use of a method, in which segmentation of users is performed according to attributes thereof and preferences of each segment are estimated beforehand, the preferences and the like are able to be estimated from attributes of the person, and the person is able to be matched with a municipality.

However, by the above described technique, it is difficult to appropriately determine preferences of a respondent, such as a person wishing to move to another place. For example, if the number of times of questioning is increased, the estimation accuracy for preferences is improved, but due to the increased burden on the person wishing to move to another place and the person getting tired of the questioning, the person is highly likely to drop out of the system before the estimation is done, and frequency of use of the system itself is also decreased. Further, the segmentation is generally performed manually, correct segmentation is not always done, and reliability of the estimation of preferences is not high.

### SUMMARY

According to an aspect of the embodiments, a non-transitory computer-readable recording medium stores therein a searching program that causes a computer to execute a process. The process includes specifying a first respondent group based on a respondent attribute of a respondent; searching for a respondent preference of the respondent utilizing a plurality of inquiries for the respondent, the plurality of inquiries being made with a first preference of the first respondent group as an initial value and corresponding to a first segment that the first respondent group belongs to; when a specific condition is not satisfied after search from the initial value with a specific number of inquiries, generating or selecting a second respondents group based on the respondent attribute, answers to the plurality of inquiries, and on preferences of a second respondent group, the second respondent group satisfying the specific condition; and searching for the respondent preference with a preference of the second respondent group being an initial value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an overall configuration of a system according to a first embodiment;

FIG. 2 is a functional block diagram illustrating a functional configuration of a search apparatus according to the first embodiment;

FIG. 3 is a diagram illustrating an example of information stored in a municipality information DB;

FIG. 4 is a diagram illustrating an example of information stored in a user attribute DB;

FIG. 5 is a diagram illustrating an example of a screen of district mapping;

FIG. 6 is a diagram illustrating space mapping for initial segmentation;

FIG. 7 is a diagram illustrating change in weights and similarity determination, according to points considered to be important;

FIG. 8 is a diagram illustrating estimation of preferences in the same segment;

FIG. 9 is a diagram illustrating resegmentation;

FIG. 10 is a diagram illustrating determination of an attribute serving as a basis for classification in the resegmentation;

FIG. 11 is a diagram illustrating labeling in the resegmentation;

FIG. 12 is a diagram illustrating resegmentation of a subject user;

FIG. 13 is a flow chart illustrating a flow of processing;

FIG. 14 is a diagram illustrating reduction in the number of times of inquiry;

FIG. 15 is a diagram illustrating the number of times of movement of a user's preferences when a method according to the first embodiment is utilized in a case where the initial segment is correct;

FIG. 16 is a diagram illustrating the number of times of movement of the user's preferences when manual questioning is used in the case where the initial segment is correct;

FIG. 17 is a diagram illustrating the number of times of movement of a user's preferences when the method according to the first embodiment is utilized in a case where the initial segment is wrong;

FIG. 18 is a diagram illustrating the number of times of movement of the user's preferences when manual questioning is used in the case where the initial segment is wrong; and

FIG. 19 is a diagram illustrating an example of a hardware configuration.

### DESCRIPTION OF EMBODIMENTS

Preferred embodiments will be explained with reference to accompanying drawings. The invention is not limited by these embodiments. Further, the respective embodiments may be combined with one another as appropriate so long as no contradiction is caused thereby.

### [a] First Embodiment

Overall Configuration

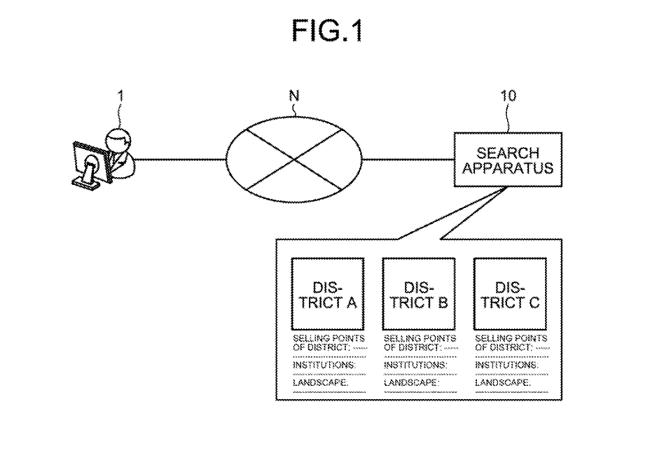

FIG. 1 is a diagram illustrating an example of an overall configuration of a system according to a first embodiment. As illustrated in FIG. 1, this system is a mover matching system, in which a user terminal 1 and a search apparatus 10 are connected to each other via a network N. Regardless of whether the network N is wired or wireless, any of various networks, such as the Internet, may be adopted.

In this system, the user terminal 1 used by a person wishing to move to another place accesses the search apparatus 10 in order to search for a place where the person is going to live. The search apparatus 10 causes the user terminal 1 to display a plurality of inquiries, estimates preferences, such as points important to the person and likings of the person, and displays any municipality matching the preferences on the user terminal 1. The system is a system that executes matching between the person wishing to move to another place and a municipality that is a moving destination, as described above.

Although the mover matching system is described as an example, the embodiment is not limited to this example. For example, the embodiment may be applied to any system that estimates preferences of a user according to an answer to inquiry to the user.

The user terminal 1 is a computer device used by the person wishing to move to another place, such as, for example, a personal computer, a mobile phone, a tablet terminal, or a smartphone. The person wishing to move to another place is an example of a respondent.

The search apparatus 10 is an example of a server apparatus that executes the above described mover matching. This search apparatus 10 stores: information related to municipalities, such as “District A, District B, and District C”; information related to users (which may, hereinafter, be referred to as “satisfied users”) for whom mover matching has finished and satisfying municipalities have been able to be retrieved; various logs input by the satisfied users; and the like.

In this system, based on a content of an answer of the respondent, the search apparatus 10 assigns the respondent to any of plural segments. Further, based on an attribute of the respondent, the search apparatus 10 specifies a group of other respondents having the attribute in common with the respondent. The search apparatus 10 then searches for preferences of the respondent, through a plurality of inquiries, which is for the respondent, and which corresponds to a segment that the group of other respondents belongs to, with preferences of the group of other respondents being initial values. Thereafter, if a specific condition is not satisfied after a predetermined number of times of inquiry and search from the initial values; based on the attribute and an answer to the inquiry, and preferences of a group of past respondents satisfying a specific condition, the search apparatus 10 generates or extracts a particular group of respondents, and searches for preferences of the respondent with preferences of the particular group of respondents being initial values.

That is, if the search apparatus 10 is unable to obtain satisfying preferences through the inquiry based on the preferences of the other respondents of the segment that is the same as that of the respondent, the search apparatus 10 performs reclassification of the respondent into a different segment and executes inquiry, and thus preferences of the respondent are able to be specified appropriately.

Functional Configuration

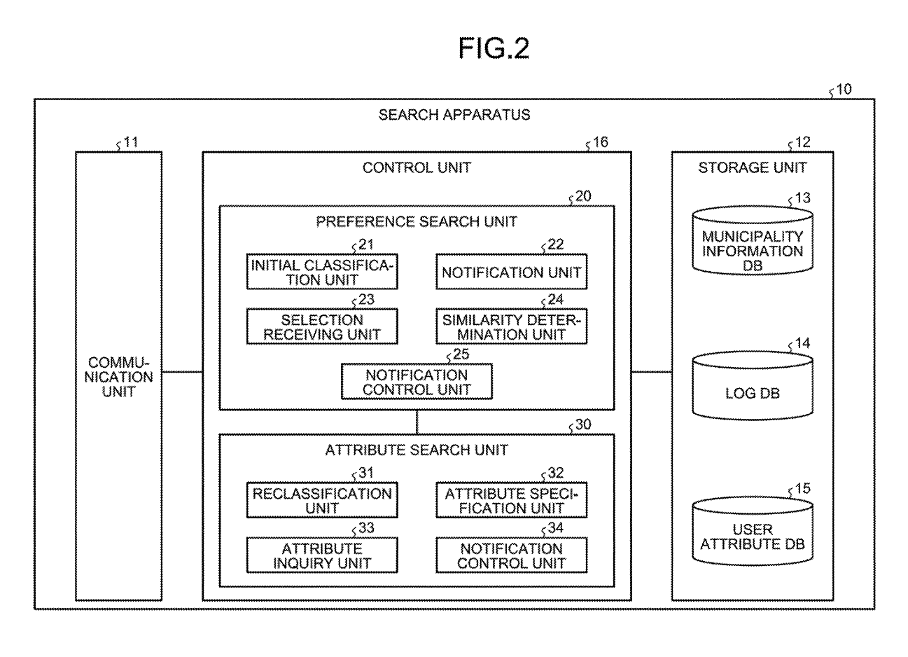

FIG. 2 is a functional block diagram illustrating a functional configuration of the search apparatus 10 according to the first embodiment. As illustrated in FIG. 2, the search apparatus 10 has a communication unit 11, a storage unit 12, and a control unit 16. The communication unit 11 is a processing unit that controls communication with another terminal, such as the user terminal 1, and is, for example, a communication interface. For example, the communication unit 11 establishes communication with the user terminal 1 through a Web browser, and realizes exchange of information on the Web browser.

The storage unit 12 is an example of a storage device that stores therein a program executed by the control unit 16, and data; and is, for example, a memory, a hard disk, or the like. This storage unit 12 stores therein a municipality information DB 13, a log DB 14, and a user attribute DB 15.

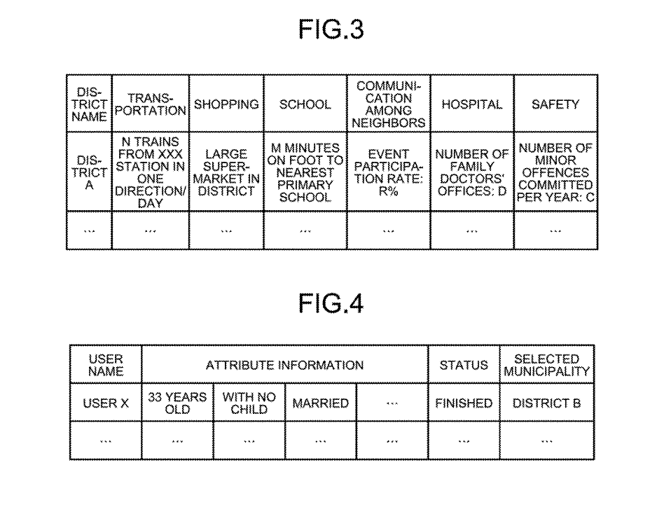

The municipality information DB 13 is a database, in which information related to municipalities to be subjected to the matching is stored. FIG. 3 is a diagram illustrating an example of the information stored in the municipality information DB 13. As illustrated in FIG. 3, the municipality information DB 13 has therein “district name”, “transportation”, “shopping”, “school”, “communication among neighbors”, “hospital”, “safety”, and the like stored in association with one another.

“District name” stored therein is a name of a district of a municipality to be a moving destination. “Transportation”, “shopping”, “school”, “communication among neighbors”, “hospital”, and “safety” are selling points of the district, and the number or contents of these points mentioned herein may be modified arbitrarily. “Transportation” is information related to convenience of transportation in the district, “shopping” is information on supermarkets and the like that are in the district, and “school” is information on establishment of schools in the district. “Communication among neighbors” is information related to communication among neighbors in the district, “hospital” is information related to hospitals in the district, and “safety” is information related to the number of crimes committed in the district or the like.

In the case of FIG. 3, in “District A”, N trains run from XXX Station in one direction per day, a large supermarket is in the district, and a walk to the nearest primary school takes M minutes. Further, in “District A”, the event participation rate is R %, the number of family doctors' offices is D, and the number of minor offences committed per year is C.

The log DB 14 is a database, in which various logs generated in the mover matching are stored. Specifically, in the log DB 14, for each user, inquiry from the search apparatus 10, response to the inquiry, attributes input by the user, and the like are stored.

The user attribute DB 15 is a database, in which various pieces of information related to users are stored. FIG. 4 is a diagram illustrating an example of the information stored in the user attribute DB 15. As illustrated in FIG. 4, the user attribute DB 15 has therein “user name”, “attribute information”, “status”, and “selected municipality”, that are stored in association with one another. “User name” stored therein is a name of a user, who is a person wishing to move to another place, and may be obtained upon a system log-in or the like. “Attribute information” is attributes of the user input or set by the user. “Status” is information indicating whether or not retrieval of a municipality to be a moving destination has finished, and “selected municipality” is a name of a municipality selected as a candidate for moving destination by the user.

FIG. 4 illustrates that “User X” has “33 years old”, “with no child”, and “married” set as attribute information, and has selected “District B” as a moving destination. A user, for which “status” is “finished” and “selected municipality” has been registered, corresponds to the above mentioned satisfied user.

The control unit 16 is a processing unit that controls the whole search apparatus 10, and is, for example, a processor. This control unit 16 has a preference search unit 20, and an attribute search unit 30. The preference search unit 20 and the attribute search unit 30 are examples of electronic circuits that the processor has, or examples of processes executed by the processor. The preference search unit 20 is an example of a specification unit and a first search unit, and the attribute search unit 30 is an example of an extraction unit and a second search unit.

The preference search unit 20 is a processing unit that: has an initial classification unit 21, a notification unit 22, a selection receiving unit 23, a similarity determination unit 24, and a notification control unit 25; and searches for preferences of a user, who is a person wishing to move to another place, in a segment, into which the user has been segmented. Specifically, the preference search unit 20 searches for a desired municipality by changing weights of the user who is the person wishing to move to another place, for a predetermined number of times, by using weights of satisfied users in the segment, into which the user who is the person wishing to move to another place has been segmented.

The initial classification unit 21 is a processing unit that classifies the person wishing to move to another place into a segment, through the user terminal 1 used by the person wishing to move to another place. Specifically, the initial classification unit 21 stores, as initial conditions, attribute information, such as “presence of child”, “school year of child”, “age group”, “ability to drive car”, “commuting method”, “martial status”, and the like, and stores the attribute information into the user attribute DB 15. The initial classification unit 21 then sets, as initial values, values of weights suitable for the attributes of the user by using priorities (which may, hereinafter, be referred to as weights) for feature quantities of districts, the priorities having been estimated from information of a questionnaire executed beforehand. Any method may be adopted in quantification of the weights. Thereafter, the initial classification unit 21 maps the user given with the initial values, in a space having features of districts as parameters.

For example, the initial classification unit 21 receives user attributes, such as “with no child” and “in the sixties”, from a new person wishing to move to another place (which may, hereinafter, be referred to as “User i” or “Ms. i”). Subsequently, the initial classification unit 21 calculates, for each satisfied user, according to attribute information and logs of past satisfied users, preestimated feature quantities of the district, “community relations”, and “convenience of transportation”, and plots the calculated feature quantities in a space.

For the plotted satisfied users, the initial classification unit 21 then executes segmentation by using an existing clustering technique, and classifies the plotted satisfied users into, for example “segment (with no child)” and “segment (with child)”. Thereafter, the initial classification unit 21 classifies the new person wishing to move to another place (User i) having the attribute, “with no child” into “segment (with no child)”. Subsequently, the initial classification unit 21 sets, as initial values of priorities, average values of “segment (with no child)”, which are: (convenience of transportation, community relations)=(7, 13).

The notification unit 22 is a processing unit that extracts, based on the user attribute, a municipality to be matched and displays the municipality on the user terminal 1 of the new person wishing to move to another place (User i). Specifically, the notification unit 22 calculates an inner product of a vector of values of feature quantities of each district and a weight vector specific to the user, and calculates a score for the district. The notification unit 22 then generates a top N list of the scores, and posts the top N list on a Web page.

In more detail, when feature quantities of a district are “community relations” and “convenience of transportation”, the notification unit 22 expresses features quantities of District A by Equation (1) using (x_{A,neig}, x_{A,tran}). Further, the notification unit 22 expresses weights to the respective feature quantities that User i has, by Equation (2) using (β_{i,neig}, β_{i,tran}). Therefore, the notification unit 22 is able to calculate a score of District A for User i by Equation (3) from an inner product of Equation (1) and Equation (2). For example, if (x_{A,neig}, x_{A,tran})=(10, 3) and (β_{i,neig}, β_{i,tran})=(7, 13), the notification unit 22 is able to calculate that Score_{i,A}=(7×10+13×3)=109. As described above, the notification unit 22 calculates a score by the above described method for each of plural districts to be candidates for moving destination, and displays a list of N top high scoring municipalities. The number for N may be determined arbitrarily.

$$\begin{matrix}{\vec{x}}_{A} = ( \begin{matrix}{x}_{A , neig} \\ {x}_{A , tran}\end{matrix} ) & ( 1 ) \\ {\vec{β}}_{i} = ( \begin{matrix}{β}_{i , neig} \\ {β}_{i , tran}\end{matrix} ) & ( 2 ) \\ {Score}_{i , A} = {\vec{β}}_{A} \cdot {\vec{x}}_{A} = {β}_{i , neig} {x}_{A , neig} + {β}_{i , tran} {x}_{A , tran} & ( 3 )\end{matrix}$$

The selection receiving unit 23 is a processing unit that receives a selection of whether or not the user has been satisfied with the list of municipalities displayed by the notification unit 22. Specifically, the selection receiving unit 23 inquires User i about whether a desired municipality is included in the top N list of municipalities displayed by the notification unit 22, and a point considered to be more important if a desired municipality is not included therein.

If the selection receiving unit 23 receives an answer that a desired municipality is included, that is, an answer that User i is satisfied, the selection receiving unit 23 sets “status” of that user in the user attribute DB 15 to “finished”. When that is done, the selection receiving unit 23 stores, in “selected municipality” of the user attribute DB 15, at least one municipality (district) selected by User i from the list displayed by the notification unit 22.

On the contrary, if the selection receiving unit 23 receives a selection of a point considered to be more important because of a desired municipality not being included, the selection receiving unit 23 randomly increases the weight of the selected point. For example, the selection receiving unit 23 receives a selection of which of “community relations” and “convenience of transportation” is considered to be more important, and randomly changes the weight vector (βᵢ) of User i by using Equation (4) following a normal distribution. For example, if User i considers the convenience of transportation to be more important, the weight vector (βᵢ) of User i, (convenience of transportation=7, community relations=13), is changed to (convenience of transportation=9, community relations=13), or the like.

β_{i,k,t+1}=β_{i,k,t}+|ν_{i,k}|(where νi,k˜N(μ,Δ_{i,k})) (4)

The similarity determination unit 24 is a processing unit that performs a search of whether or not a satisfied user having weights similar to the weights of User i that have been randomly changed by the selection receiving unit 23 is present in the same segment as User i. Specifically, the similarity determination unit 24 calculates a similarity between weights of each satisfied user in the same segment as User i, with the weights of User i that have been randomly changed by the selection receiving unit 23, by using cosine similarities, Euclidean distances, or the like.

As to the above described example, the similarity determination unit 24 calculates a cosine similarity between the randomly increased weights of User i, (convenience of transportation=9, community relations=13), and those of each of Satisfied Users x, y, j, and z. When the similarity determination unit 24 calculates the cosine similarity between the weights of User i, (convenience of transportation=9, community relations=13), and weights of Satisfied User j, (convenience of transportation=9, community relations=12) (Equation (5)), since the cosine similarity is the highest and is larger than a threshold (for example, “0.7”), the similarity determination unit 24 determines that the weights of User i and the weights of User j are similar to each other.

$$sim ( \vec{p} , \vec{q} ) = \frac{\vec{p} \cdot \vec{q}}{\vert \vec{p} \vert \vert \vec{q} \vert} = \frac{2 \cdot 2 + 0 \cdot ( - 1 )}{\sqrt{{2}^{2} + {0}^{2}} \cdot \sqrt{{2}^{2} + {( - 1 )}^{2}}} = \frac{4}{2 \sqrt{5}} > 0.7 \qquad ( 5 )$$

As a result, the similarity determination unit 24 assumes that the weights of Satisfied User j are likely to be closer to true preferences of User i, and regards the weights of Satisfied User j as the weights of User i. That is, the similarity determination unit 24 changes the weights of User i to the weights of Satisfied User j, (convenience of transportation=9, community relations=12), rather than to the randomly increased weights, (convenience of transportation=9, community relations=13), and outputs the changed weights to the notification control unit 25. If a satisfied user with a similarly equal to or larger than the threshold is not found, the similarity determination unit 24 outputs the randomly changed weights of User i, (convenience of transportation=9, community relations=13), as they are, to the notification control unit 25.

The notification control unit 25 is a processing unit that extracts a municipality to be matched by using the weights of User i input from the similarity determination unit 24, and displays the extracted municipality on the user terminal 1 of User i. Specifically, the notification control unit 25 calculates a score by the above described method for each of plural districts to be candidates for moving destination by using a method similar to that of the notification unit 22, and displays a list of top N high scoring municipalities.

The notification control unit 25 inquires User i about whether or not a desired municipality is included, and a point considered to be more important if a desired municipality is not included. If the notification control unit 25 receives an answer that a desired municipality is included, that is, an answer that User i is satisfied, the notification control unit 25 stores various pieces of information in the user attribute DB 15.

On the contrary, if a desired municipality is not included, and the number of times a point considered to be important has been selected, that is, the number of times similarity calculation has been performed, is less than a threshold; the notification control unit 25 instructs the selection receiving unit 23 to continue the processing. That is, the selection receiving unit 23 inquires User i about a point considered to be more important, and the similarity determination unit 24 executes a search for a similar satisfied user.

Further, if a desired municipality is not included, and the number of times a point considered to be important has been selected, that is, the number of times similarity calculation has been performed, is equal to or larger than the threshold; the notification control unit 25 requests the attribute search unit 30 to start processing. That is, the notification control unit 25 determines that the initial segment is highly likely to have been wrong, and requests the attribute search unit 30 to start resegmentation.

The attribute search unit 30 is a processing unit that: has a reclassification unit 31, an attribute specification unit 32, an attribute inquiry unit 33, and a notification control unit 34; and reviews the classification according to attributes, by executing resegmentation of User i, who is the person wishing to move to another place. That is, the attribute search unit 30 more sharply changes the weights, which are values of indices, for the user who has not been satisfied even if the list has been updated for a certain number of times or more by the preference search unit 20.

The reclassification unit 31 is a processing unit that executes segmentation again by using a clustering technique, from existing attribute information of satisfied users. That is, since as the number of users who have used the system increases, the number of satisfied users increases; for a new user yet to be satisfied, the reclassification unit 31 changes the weights greatly by correcting the segmentation itself, based on weights of the satisfied users.

As to the above described example, in the state where classification has been performed into “segment (with no child)” and “segment (with child)”, the reclassification unit 31 performs classification into “segment with a predetermined number or more of those with no child and a predetermined number or more of those in twenties to thirties”, “segment with a predetermined number of more of those with child and a predetermined number or more of those in forties to fifties”, and “segment with a predetermined number or more of those with child and a predetermined number or more of those in sixties or over”, by performing clustering again. The reclassification unit 31 notifies the attribute specification unit 32 of these results of the classification.

The attribute specification unit 32 is a processing unit that specifies attributes of each segment classified by the reclassification unit 31. Specifically, the attribute specification unit 32 specifies, from the results of the resegmentation, an attribute different from the attribute that has been used by the initial classification unit 21 as a basis of the classification, as a basis of classification.

As to the above described example, the attribute specification unit 32 receives, as results of the classification from the reclassification unit 31, “segment with a predetermined number or more of those with no child and a predetermined number or more of those in twenties to thirties”, “segment with a predetermined number of more of those with child and a predetermined number or more of those in forties to fifties”, and “segment with a predetermined number or more of those with child and a predetermined number or more of those in sixties or over”. The attribute specification unit 32 then excludes “presence of child” that has been used by the initial classification unit 21 as the basis of the classification, and determines that classification by “age group” is appropriate.

As a result, the attribute specification unit 32 sets the segments classified by the reclassification unit 31 respectively as “segment (twenties to thirties)”, “segment (forties to fifties)”, and “segment (sixties or over)”. That is, the attribute specification unit 32 executes labeling of “twenties to thirties”, “forties to fifties”, and “sixties or over”, for the respective segments. The attribute specification unit 32 outputs these results of the labeling to the attribute inquiry unit 33.

The attribute inquiry unit 33 is a processing unit that executes inquiry for classification of User i being processed, into one of the respective segments resulting from the resegmentation. Specifically, the attribute inquiry unit 33 executes inquiry to the user terminal 1 of User i according to the labeling input from the attribute specification unit 32.

As to the above described example, the attribute inquiry unit 33 inquires User i about which one of “twenties to thirties”, “forties to fifties”, and “sixties or over”, User i corresponds to. The attribute inquiry unit 33 may automatically perform determination according to attribute information received from User i without making the inquiry. The attribute inquiry unit 33 specifies the attribute to be “sixties or over” and notifies the notification control unit 34 of the attribute.

The notification control unit 34 is a processing unit that classifies User i into a corresponding segment according to the attribute obtained as a result of the inquiry by the attribute inquiry unit 33. Specifically, the notification control unit 34 classifies User i to be processed, into a new segment, and newly sets weights of User i. The notification control unit 34 calculates the above described score for each district, generates a top N list, and posts the top N list on a Web page.

As to the above described example, the notification control unit 34 classifies User i into a segment (sixties or over), and sets average values of weights of satisfied users corresponding to the segment (sixties or over) as new weights, (convenience of transportation=18, community relations=6), of User i. The notification control unit 34 calculates a score for each district by using these new weights of User i, and displays a list of top N high scoring municipalities.

The notification control unit 34 receives a selection of whether or not the user has been satisfied with the list of municipalities displayed, and if the user has been satisfied, the notification control unit 34 stores various pieces of information in the user attribute DB 15 and ends the processing. On the contrary, if User i is not satisfied with the displayed list of municipalities, and the number of repetitions is less than a threshold, the notification control unit 34 notifies the preference search unit 20 of new weights, (convenience of transportation=18, community relations=6), of User i and the segment (sixties or over). The preference search unit 20 that has received this notification searches for a desired municipality by using the received information. Further, if User i is not satisfied with the displayed list of municipalities and the number of repetitions is equal to or larger than the threshold, the notification control unit 34 determines that there are no corresponding municipalities and ends the processing. The notification control unit 34 may repeat the processing according to the user's will until the user is satisfied.

### Specific Example

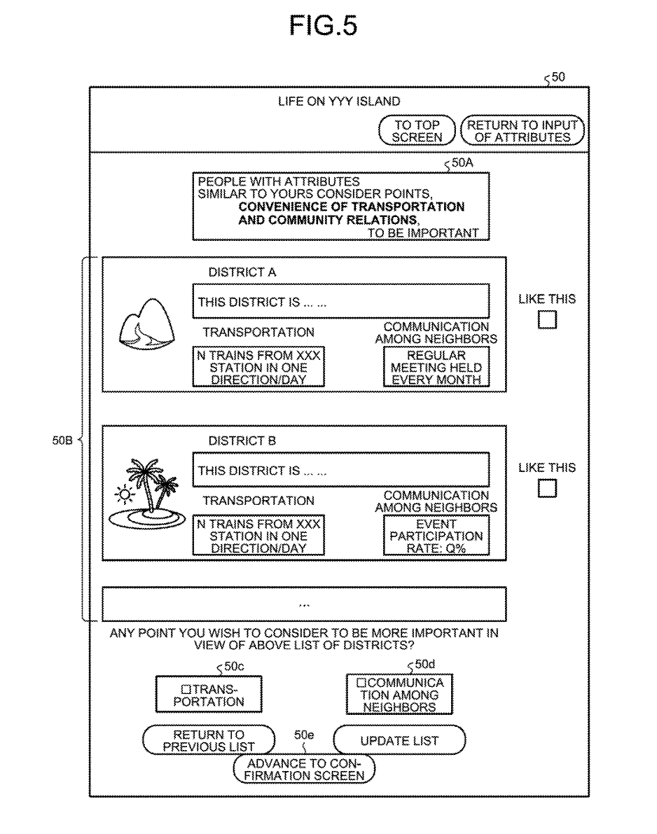

Next, the above described example will be specifically described. Herein, processing will be specifically described by space mapping, for an example, which is the case where a new user is User i, and points considered to be important are the two points, “convenience of transportation” and “community relations”. Firstly, the initial classification unit 21 displays a screen 50 illustrated in FIG. 5 on the user terminal 1 that has executed a log-in or the like.

FIG. 5 is a diagram illustrating an example of a screen for district mapping. The screen 50 illustrated in FIG. 5 is an example of an initial screen displayed upon the log-in. As illustrated in FIG. 5, an area 50A on this screen 50 is an area, in which attributes of User i or items considered to be important by User i are displayed, and is updated by processing of the attribute search unit 30. An area 50B is an area, in which a list of municipalities matched with User i, that is, an area, in which a top N list is displayed, and is updated by processing of the preference search unit 20. A button 50c and a button 50d are buttons, through which selection of items considered to be important is received; and when the convenience of transportation is considered to be important, the button 50c is selected, and when the community relations are considered to be important, the button 50d is selected. A button 50e is a button for advancing to a confirmation screen, and is pressed down when a satisfying municipality has been retrieved. That is, a user who has selected the button 50e becomes a satisfied user from a new user.

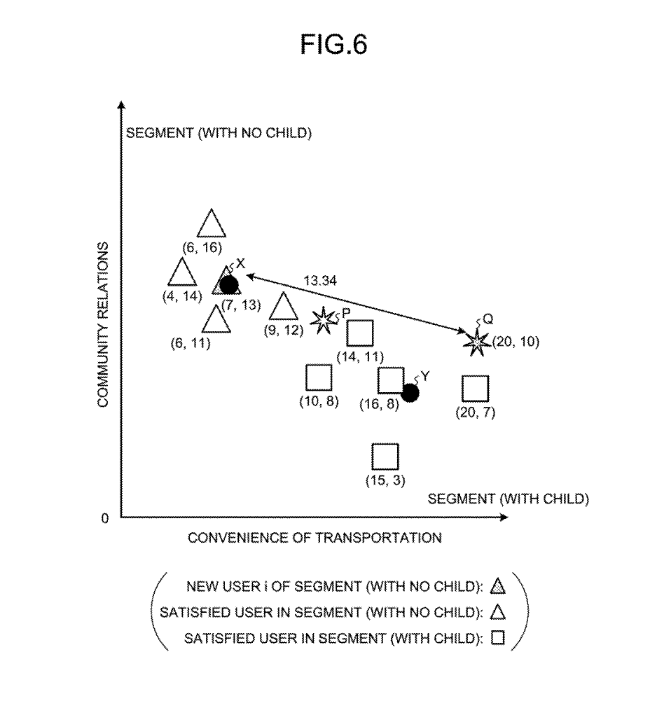

Subsequently, the initial classification unit 21 receives, from the user terminal 1, as user attributes of User i, “with no child”, “in the sixties”, and the like. Subsequently, the initial classification unit 21 plots, for satisfied users, “convenience of transportation” and “community relations”. FIG. 6 is a diagram illustrating space mapping for initial segmentation. As illustrated in FIG. 6, the initial classification unit 21 plots, on a two-dimensional space of “convenience of transportation” and “community relations”, respective weights of “convenience of transportation” and “community relations” of the satisfied users, and from results of the plotting, performs classification into two segments, “segment (with no child)” and “segment (with child)”. Since a user attribute of User i is “with no child”, the initial classification unit 21: classifies User i into “segment (with no child)”; sets, as weights of User i, “7” and “13”, which are average values of weights of “convenience of transportation” and “community relations” of the satisfied users in “segment (with no child)”; and plots the weights as a point X on FIG. 6. In FIG. 6, a point Y corresponds to average values of weights of “convenience of transportation” and “community relations” of the satisfied users of “segment (with child)”. A point P corresponds to true preferences (weights) of User i when the segment is correct, and a point Q corresponds to true preferences (weights) of User i when the segment is wrong.

Thereafter, the notification unit 22 calculates a score for each district by calculating an inner product of a vector of values of feature quantities of the district and a vector of weights, (7, 13), specific to User i. The notification unit 22 then generates a top N list of the scores, and displays the top N list in the area 50B on the screen 50 in FIG. 5. When the selection receiving unit 23 detects a selection of the button 50e, the selection receiving unit 23 determines User i as a satisfied user, stores various pieces of information, and ends the processing.

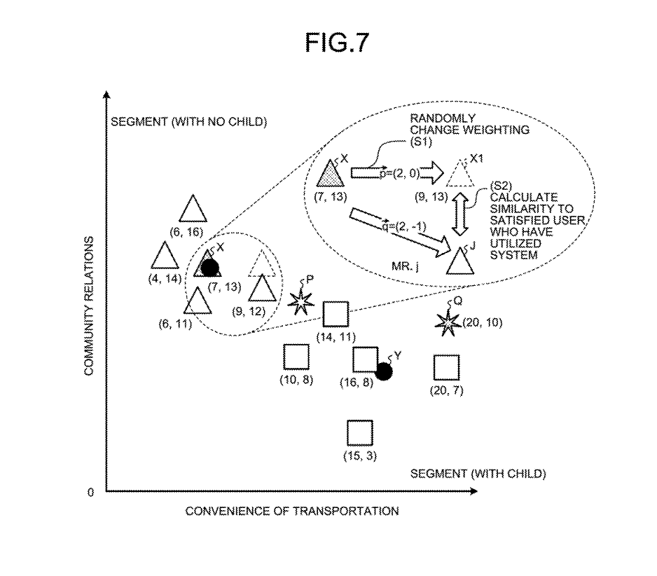

On the contrary, if the button 50c for transportation is selected, the selection receiving unit 23 determines that User i considers the convenience of transportation to be more important, and randomly increases the weight thereof (see Equation (4)). Further, the similarity determination unit 24 determines a similarity between the weights of User i and weights of each of the satisfied users in the same segment. FIG. 7 is a diagram illustrating change in weights and similarity determination, according to points considered to be important. As illustrated in FIG. 7, the selection receiving unit 23 generates a point X1, “convenience of transportation=9, community relations=13”, that has been changed from the point X, “convenience of transportation=7, community relations=13”, by randomly increasing the weight of “convenience of transportation” that has been selected (Step S1). The similarity determination unit 24 then calculates a similarity between the point X1, “convenience of transportation=9, community relations=13”, which corresponds to the new weights of User i, and weights of each of the satisfied users in the same segment as User i (Step S2).

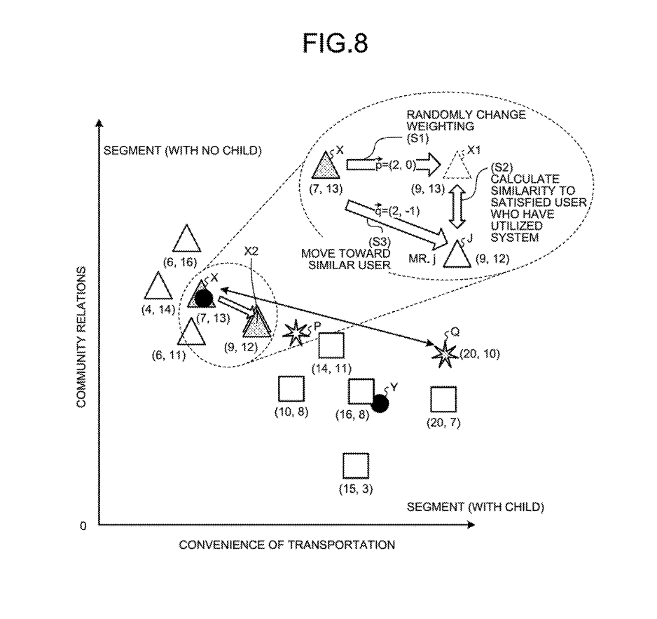

Thereafter, the similarity determination unit 24 estimates, as preferences of User i, preferences of User j with the highest similarity. FIG. 8 is a diagram illustrating estimation of preferences in the same segment. As illustrated in FIG. 8, the similarity determination unit 24 detects that a similarity between the point X1, “convenience of transportation=9, community relations=13”, corresponding to the weights of User i, and the weights, “convenience of transportation=9, community relations=12”, of Satisfied User j, is the highest. The similarity determination unit 24 then changes the weights of User i to the weights, “convenience of transportation=9, community relations=12”, of Satisfied User j (Step S3). As a result, the similarity determination unit 24 plots a point X2, “convenience of transportation=9, community relations=12”, in the space, as weights of User i.

Thereafter, the notification unit 22 calculates a score for each district by calculating an inner product of a vector of values of feature quantities of the district and a vector of weights, (9, 13), specific to User i. The notification unit 22 then generates a top N list of the scores, and displays the top N list in the area 50B on the screen 50 in FIG. 5. When the selection receiving unit 23 detects a selection of the button 50e, the selection receiving unit 23 determines User i as a satisfied user, stores various pieces of information, and ends the processing.

When results that satisfy User i are not obtained even if the processing described with respect to FIG. 6 to FIG. 8 has been repeated for a number of times equal to or larger than a threshold, resegmentation is executed. Specifically, the attribute search unit 30 causes an update button, for “Do you wish to execute resegmentation?”, “Do you wish to execute reclassification?”, or the like, to be displayed on the screen 50 in FIG. 5, the screen 50 having been displayed after a plural number of times. When the update button is selected, the attribute search unit 30 executes resegmentation.

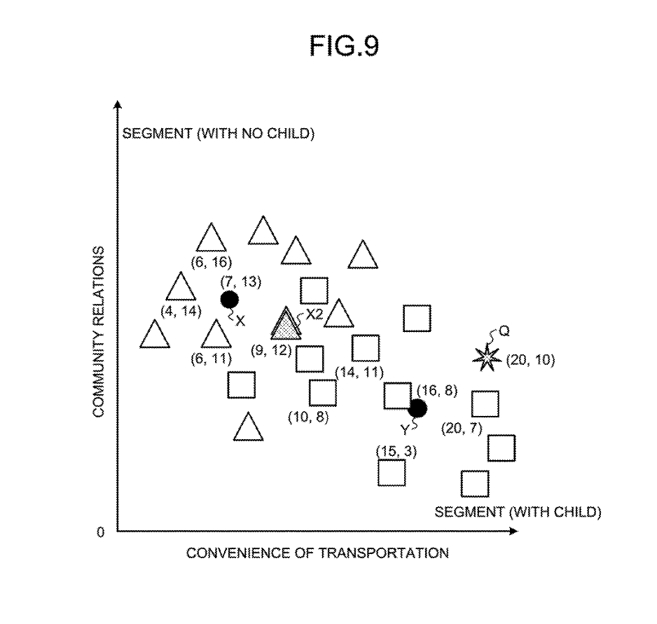

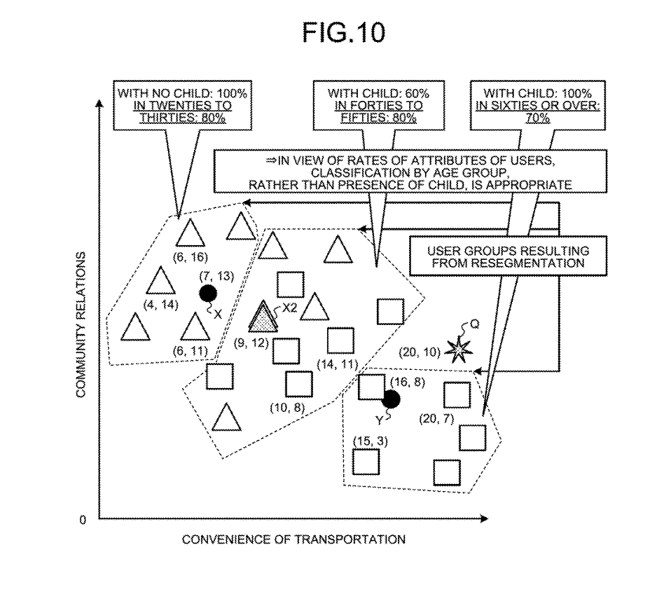

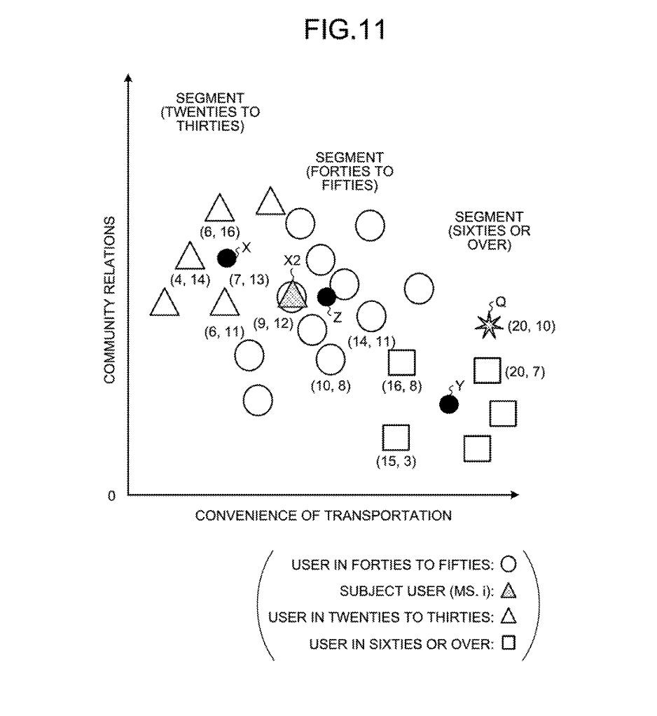

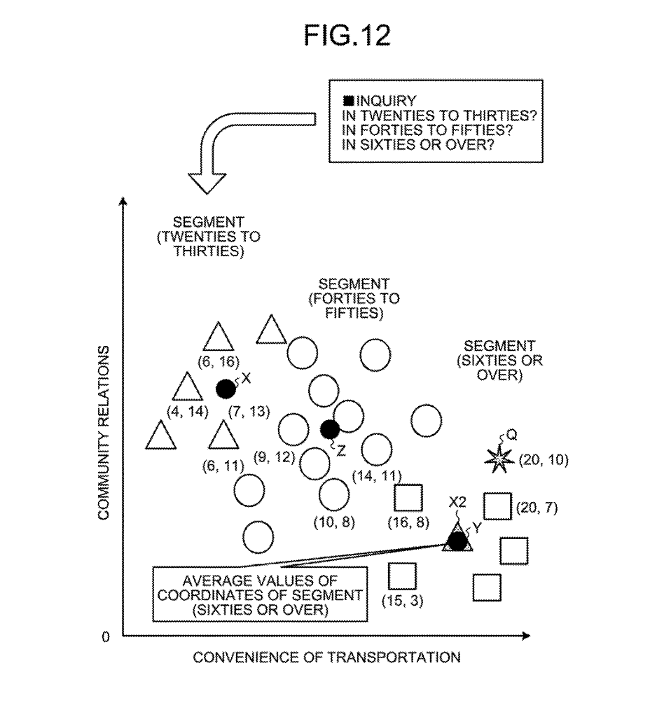

FIG. 9 is a diagram illustrating resegmentation, FIG. 10 is a diagram illustrating determination of an attribute that becomes a basis for classification in the resegmentation, and FIG. 11 is a diagram illustrating labeling in the resegmentation. FIG. 12 is a diagram illustrating resegmentation for a subject user.

As illustrated in FIG. 9, the reclassification unit 31 replots weights of “convenience of transportation” and “community relations” including those of a satisfied user, for which satisfying results have been obtained in the processing for User i. Subsequently, as illustrated in FIG. 10, in a state where classification has been performed into “segment (with no child)” and “segment (with child)”, the reclassification unit 31 performs classification into “segment with a predetermined number or more of those with no child and a predetermined number or more of those in twenties to thirties”, “segment with a predetermined number of more of those with child and a predetermined number or more of those in forties to fifties”, and “segment with a predetermined number or more of those with child and a predetermined number or more of those in sixties or over”, by performing clustering again.

As illustrated in FIG. 11, as a result of the reclustering, the attribute specification unit 32 then determines that classification by “age group” is appropriate, and generates the respective segments, “segment (twenties to thirties)”, “segment (forties to fifties)”, and “segment (sixties or over)”.

Thereafter, as illustrated in FIG. 12, the attribute inquiry unit 33 inquires User i about which one of the attributes, “in the twenties to thirties”, “in the forties to fifties”, and “in the sixties or over”, labeled by the attribute specification unit 32, User i corresponds to. When the notification control unit 34 receives a result of the inquiry, “in the sixties or over”, the notification control unit 34 then classifies User i into “segment (sixties or over)”. Thereafter, the notification control unit 34 sets average values of weights of satisfied users in “segment (sixties or over)” as weights of User i, and plots the weights of User i as a point X2 on FIG. 12.

By using the weights of the point X2, the notification control unit 34 displays a top N list, and displays the top N list in the area 50B on the screen 50 in FIG. 5. When the notification control unit 34 detects a selection of the button 50e, the notification control unit 34 determines User i as a satisfied user, stores various pieces of information, and ends the processing. On the contrary, if User i is not satisfied, the processing from FIG. 6 is executed again with the point X2 being a starting point.

Flow of Processing

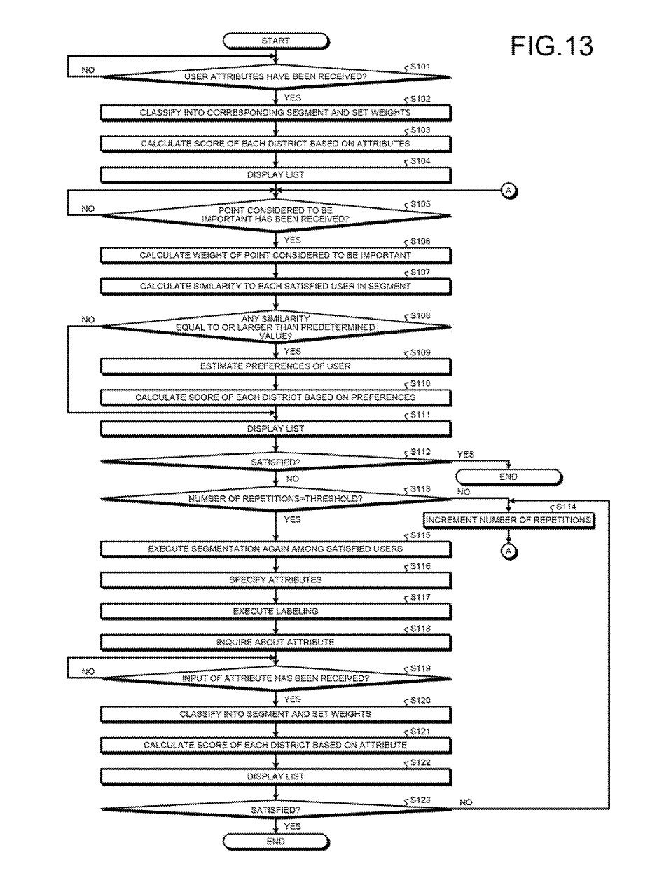

FIG. 13 is a flow chart illustrating a flow of processing. As illustrated in FIG. 13, when the preference search unit 20 receives user attributes (S101: Yes), the preference search unit 20 classifies a new user into a corresponding segment, and sets average values of weights of satisfied users in the classified segment as weights of the new user (S102).

Subsequently, for the new user, the preference search unit 20 calculates a score of each district based on the attributes (S103), and displays a top N list (S104). Subsequently, when the preference search unit 20 receives a selection of a point considered to be important from the user (S105: Yes), the preference search unit 20 calculates a weight of the point considered to be important so as to randomly increase the weight (S106).

The preference search unit 20 then calculates a similarity between calculated new weights of the user and weights of each satisfied user in the same segment as the user (S107). When the preference search unit 20 detects a similarity equal to or larger than a predetermined value (S108: Yes), the preference search unit 20 estimates preferences of the user (S109). Specifically, the preference search unit 20 changes the weights of the user to the weights of the satisfied user with the highest similarity. When the preference search unit 20 does not detect any similarity equal to or larger than the predetermined value (S108: No), the preference search unit 20 executes the processing from S111 by using calculated new weights of the user.

Thereafter, the preference search unit 20 calculates a score of each district by using the changed weights of the user (S110), and displays a top N list (S111). If the user is satisfied, that is, if the button 50e, which is illustrated in FIG. 5 and is for advancing to the confirmation screen, is selected (S112: Yes), the preference search unit 20 stores user information and ends the processing.

On the contrary, if the user is not satisfied, that is, if the button 50e, which is illustrated in FIG. 5 and is for advancing to the confirmation screen, is not selected (S112: No), and the number of repetitions of the processing does not exceed a threshold (S113: No), the preference search unit 20 increments the number of repetitions (S114), and repeatedly executes the processing from S105.

On the contrary, if the number of repetitions of the processing from S105 to S112 exceeds the threshold (S113: Yes), the attribute search unit 30 executes segmentation again among the satisfied users (S115). Subsequently, the attribute search unit 30 specifies, from results of the segmentation executed again, new attributes to be subjected to classification (S116), and executes labeling for that segmentation (S117).

Subsequently, in order to perform classification according to segmentation that has been subjected to labeling, when the attribute search unit 30 inquires the user about attributes (S118) and receives input of the attributes (S119: Yes), the attribute search unit 30 classifies the new user into a new segment according to the received attributes, and sets average values of weights of satisfied users in the classified segment as weights of the new user (S120).

For the new user, the attribute search unit 30 then calculates a score of each district based on the attributes (S121), and displays a top N list (S122). If the user is satisfied, that is, if the button 50e, which is illustrated in FIG. 5 and is for advancing to the confirmation screen, is selected (S123: Yes), the attribute search unit 30 stores user information and ends the processing.

On the contrary, if the user is not satisfied, that is, if the button 50e, which is illustrated in FIG. 5 and is for advancing to the confirmation screen, has not been selected (S123: No), the attribute search unit 30 increments the number of repetitions of the processing (S114), and repeatedly executes the processing from S105.

The number of repetitions of the processing from S105 to S112 executed by the preference search unit 20 and the number of repetitions of the processing from S115 to S123 executed by the attribute search unit 30 may be managed separately from each other.

Effects

As described above, by correcting manually determined segmentation through use of a history of users who have actually utilized the system, the search apparatus 10 enables the segmentation to be made gradually closer to correct segmentation even if the manually generated segmentation is wrong. Further, by implementing segmentation again through a plural number of times of questioning and presentation of information, for a user not satisfied due to wrong segmentation, the search apparatus 10 enables a gap of the segmentation from the true preferences to be filled.

As described above, by using preferences of past respondents specified by segmentation based on attributes as initial values, the search apparatus 10 is able to retrieve preferences early, and even if retrieval of the preferences does not work well, by utilizing results of segmentation from preferences based on answers, the search apparatus 10 is able to execute a search by utilization of new initial values. Therefore, the search apparatus 10 is able to obtain appropriate answers while preventing the number of times of questioning from increasing, and is able to present municipalities matching the preferences of the user.

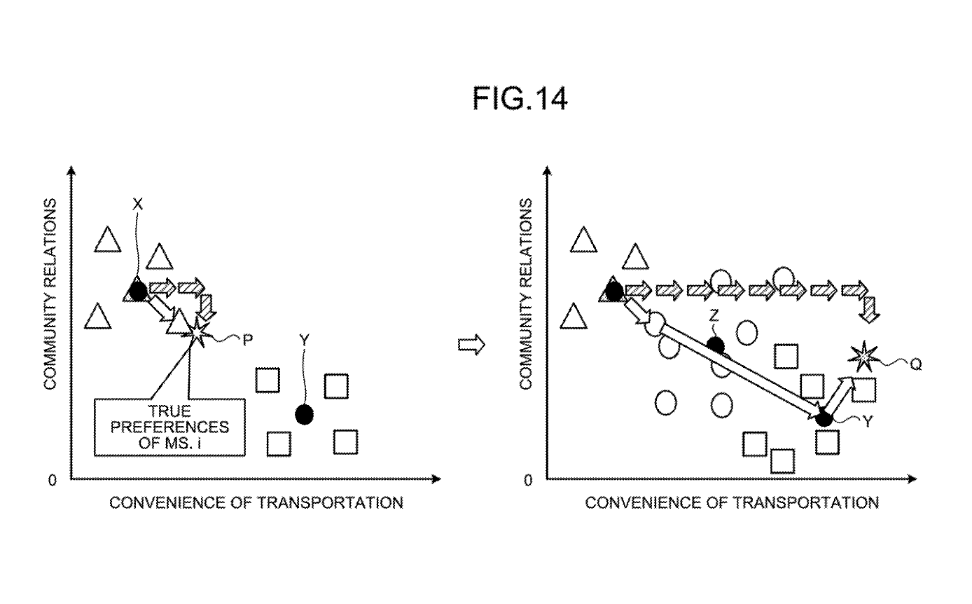

FIG. 14 is a diagram illustrating reduction in the number of times of inquiry. Since respective points illustrated in FIG. 14 are similar to those in FIG. 6, detailed description thereof will be omitted. The left figure of FIG. 14 corresponds to the processing, which corresponds to S101 to S114 in FIG. 13, and in which weights are changed in the same segment to be made closer to true preferences of User i. As illustrated in the left figure of FIG. 14, if the initial segment, into which User i has been classified, is comparatively correct, the search apparatus 10 is able to reach the true preferences by using existing data of satisfied users in a small number of repetitions. On the contrary, in a case of a related technique, since the true preferences are approached by repetition of inquiry, the number of times of inquiry is increased. For example, even in a case where inquiry is executed for three times in the related technique, the search apparatus 10 is able to specify the true preferences of User i by specifying preferences of a satisfied user similar to User i in inquiry of once.

Further, the right figure of FIG. 14 corresponds to the processing, which corresponds to S115 to S123 in FIG. 13 and, in which true preferences of User i are approached by execution of change of segments. As illustrated in the right figure of FIG. 14, even if the initial segment is far from the true preferences, through resegmentation, the true preferences are able to be approached radically. On the contrary, in a case of a related technique, the true preferences are approached through repetition of inquiry similarly to the left figure of FIG. 14, but since the initial segment is wrong, the number of times of inquiry is much larger than usual. For example, even in a case where inquiry is executed for nine times in the related technique, the search apparatus 10 is able to specify the true preferences of User i by specifying preferences of a satisfied user similar to User i in inquiry for three times.

Comparison

Experimental results of when the method of the first embodiment was used, and experimental results of when a related method (manual questioning) was used are compared with each other. Movement of preferences of a user may be referred to as, for simplification, “movement of the user”, for short.

Experimental Results of when Initial Segment is Correct

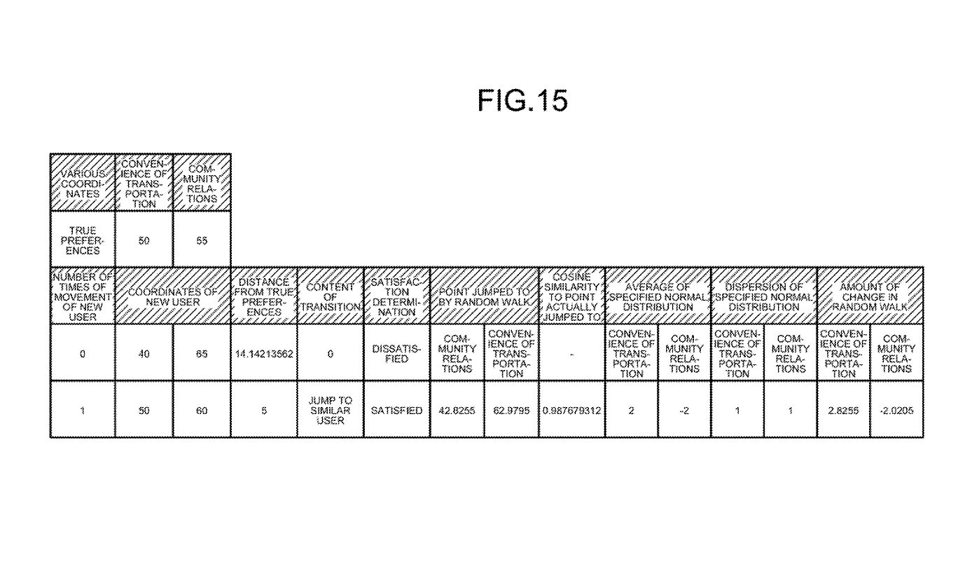

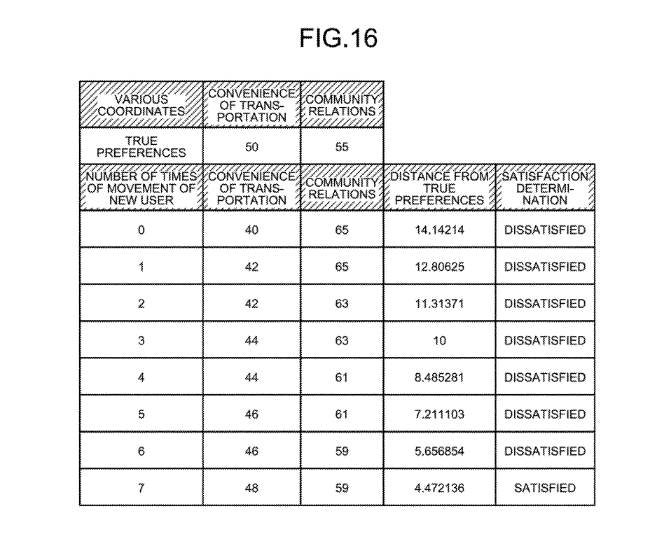

FIG. 15 is a diagram illustrating the number of times of movement of a user's preferences when the method according to the first embodiment is utilized in a case where the initial segment is correct, and FIG. 16 is a diagram illustrating the number of times of movement of the user's preferences when manual questioning is used in the case where the initial segment is correct. Herein, true preferences for (convenience of transportation, community relations) are (50, 55), and when a distance from the true preferences becomes equal to or less than “5”, a new user (person wishing to move to another place) is satisfied. Averages of a specified normal distribution are (convenience of transportation, community relations)=(2, −1), and dispersions of the specified normal distribution are (convenience of transportation, community relations)=(1, 1).

As illustrated in FIG. 15, preferences of the new user are initially placed at the center of a belonging segment, (convenience of transportation, community relations)=(40, 65). Since a distance between this position, (40, 65), and the true preferences is “14.14214”, the new user is dissatisfied. Subsequently, the preferences of the new user are randomly increased from this position to be moved to “42.8255, 62.9795”, and a cosine similarity between this position and preferences of each satisfied user in the same segment is calculated. The preferences of the new user are then moved to (50, 60), where the cosine similarity is “0.98767 . . . ”. This position (50, 60) is a position where amounts of change from the initial values by random walk are 2.8255 for “convenience of transportation” and “−2.0205” for “community relations”.

Since a distance between this position (50, 60) after the movement and the true preferences is “5”, the new user is satisfied. That is, the number of times of movement of the user's preferences when the method according to the first embodiment is utilized in the case where the initial segment is correct is once. The average number of times of movement when the above experiment was executed five times, with preferences (position) of each satisfied user in the same segment being fixed and values of random number seeds upon random walk being changed, was twice.

On the contrary, FIG. 16 is an example, in which a new user is moved by use of results of questioning, from (convenience of transportation, community relations)=(40, 65) where the new user has been placed, and the movement is repeated until the distance from the true preferences becomes equal to or less than “5”. As illustrated in FIG. 16, the user is initially placed at (40, 65). Since a distance between this position (40, 65) and the true preferences is “14.14212”, the new user is dissatisfied. The preferences of the user move to (42, 65) according to response to first questioning, after being placed initially at (40, 65). Since a distance between this position (42, 65) and the true preferences is “12.80625”, the new user is dissatisfied.

Subsequently, after being placed at (42, 65), the preferences of the user are moved to (42, 63) according to response to second questioning. Since a distance between this position (40, 63) and the true preferences is “11.31371”, the new user is dissatisfied. Accordingly, by questioning being repeated, the distance from the true preferences is shortened, and satisfying results are obtained after a seventh time. That is, the number of times of movement of the user's preferences when manual questioning is used in the case where the initial segment is correct is seven times.

As described above, more than manual questioning being repeated, use of the method of the first embodiment enables the number of times of questioning to be decreased and the user to approach the true preferences.

Experimental Results of when Initial Segment is Wrong

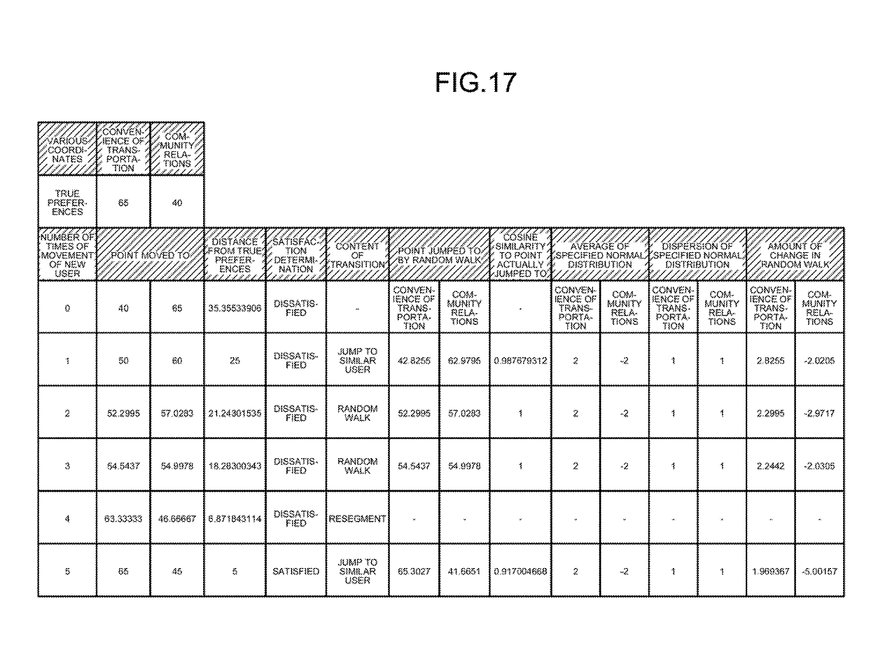

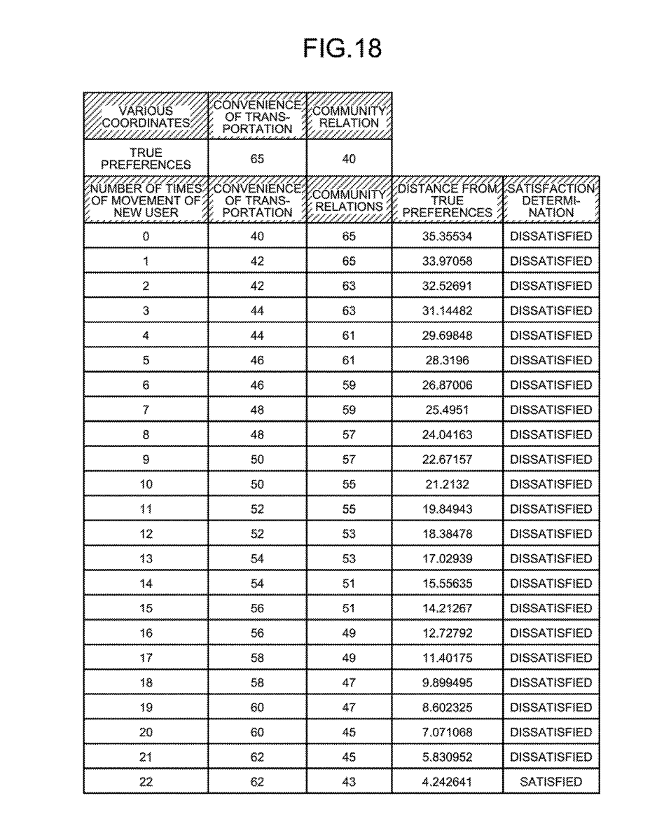

FIG. 17 is a diagram illustrating the number of times of movement of a user's preferences when the method according to the first embodiment is utilized in a case where the initial segment is wrong, and FIG. 18 is a diagram illustrating the number of times of movement of the user's preferences when manual questioning is used in the case where the initial segment is wrong. Herein, true preferences for (convenience of transportation, community relations) are (65, 40), and when a distance from the true preferences becomes equal to or less than “5”, a new user (person wishing to move to another place) is satisfied. Averages of a specified normal distribution are (convenience of transportation, community relations)=(2, −1), and dispersions of the specified normal distribution are (convenience of transportation, community relations)=(1, 1).

As illustrated in FIG. 17, preferences of the new user are initially placed at the center of a belonging segment, (convenience of transportation, community relations)=(40, 65). Since a distance between this position (40, 65) and the true preferences is “38.355 . . . ”, the new user is dissatisfied. Subsequently, the preferences of the new user are randomly increased from this position to be moved to “42.8255, 62.9795”, and a cosine similarity between this position and preferences of each satisfied user in the same segment is calculated. The preferences of the new user are then moved to (50, 60), where the cosine similarity is “0.98767 . . . ”.

Since a distance between this position (50, 60) and the true preferences is “25”, the new user is dissatisfied. Subsequently, the preferences of the new user are randomly increased from this position to be moved to “52.2995, 57.0283”, and a cosine similarity between this position and preferences of each satisfied user in the same segment is calculated. However, since no existing user (satisfied user) with a cosine similarity equal to or larger than “0.7” is detected, preferences of the user are specified to be (52.2995, 57.0283).

Since a distance between this position (52.2995, 57.0283) and the true preferences is “21.243 . . . ”, the new user is dissatisfied. Subsequently, the preferences of the new user are randomly increased from this position to be moved to “54.5437, 57.9978”, and a cosine similarity between this position and preferences of each satisfied user in the same segment is calculated. However, since no existing user (satisfied user) with a cosine similarity equal to or larger than “0.7” is detected, the preferences of the user are specified to be (54.5437, 57.9978).

Since a distance between this position (54.5437, 57.9978) and the true preferences is “18.2830 . . . ”, the new user is dissatisfied. Since movement in the same segment has been executed for a number of times equal to or larger than a threshold (three times, in this example), resegmentation is executed. As a result, the preferences of the user are moved to (63.3333, 46.6667), and since a distance between this position (63.3333, 46.6667) and the true preferences is “6.8718 . . . ”, the new user is dissatisfied.

Subsequently, the preferences of the new user are randomly increased from this position to be moved to “65, 45”, and since a distance between this position and the true preferences is “5”, the new user is satisfied. That is, the number of times of movement of the user's preferences when the method according to the first embodiment is utilized in the case where the initial segment is wrong is five times. The average number of times of movement when the above experiment was executed five times, with preferences (position) of each satisfied user in the same segment being fixed and values of random number seeds upon random walk being changed, was also five times.

On the contrary, FIG. 18 is an example, in which a new user is moved by use of results of questioning, from (convenience of transportation, community relations)=(40, 65) where the new user has been placed, and the movement is repeated until a distance from the true preferences becomes equal to or less than “5”. As illustrated in FIG. 18, the user is initially placed at (40, 65). Since a distance between this position (40, 65) and the true preferences is “35.35334”, the new user is dissatisfied. The preferences of the user then move to (42, 65) according to response to first questioning, after being placed initially at (40, 65). Since a distance between this position (42, 65) and the true preferences is “33.97058”, the new user is dissatisfied.

Accordingly, by questioning being repeated, the distance from the true preferences is shortened, and satisfying results are obtained after a 22nd time. That is, since the initial segment is wrong, in other words, since classification of attributes of the user is wrong, the first questioning is misdirected, and the number of times of questioning is inevitably increased.

As described above, even in the case where the first segment is correct, the search apparatus 10 enables reduction in the number of times of questioning needed for true preferences of the user. Further, in the case where the initial segment is not correct, as compared to the related technique, the search apparatus 10 enables even more significant reduction in the number of times of questioning needed for the true preferences of the user.

### [b] Second Embodiment

An embodiment of the present invention has been described above, but in addition to the above described embodiment, the present invention may be implemented through various other different modes.

Points Considered to be Important

In the above described embodiment, mapping of “convenience of transportation” and “community relations” in a two-dimensional space has been described as an example, but not being limited thereto, any combination of “transportation”, “shopping”, “school”, “communication among neighbors”, “hospital”, and “safety”, that are illustrated in FIG. 3, may be used. For example, if all of these are adopted; inquiry is made about which of the above six is/are points considered to be important, mapping is executed in a six-dimensional space, and the processing from FIG. 6 to FIG. 12 is executed.

Weight

In the above described example, an example, in which priorities of feature quantities of districts are estimated by use of information of a questionnaire executed beforehand, has been described, but not being limited thereto, any of various methods may be used. For example, a satisfied user may be made to set priorities of the six points illustrated in FIG. 3 and convert them into numerical values, or the priorities may be converted into numerical values through multiplication by a predetermined coefficient. Further, instead of priorities, ten-grade evaluation may be made or marks may be set.

An example of derivation of weights through a questionnaire will now be described. Firstly, virtual districts are prepared. Herein, “district, feature quantity of convenience of transportation, and feature quantity of community relations” are defined to be “District A, convenience of transportation (30), and community relations (20)”, “District B, convenience of transportation (20), and community relations (40)”, and “District C, convenience of transportation (10), and community relations (30)”.

Next, a subject (person wishing to move to another place) is made to select which of these districts the subject wishes to live in through a questionnaire. It will be assumed herein that Subject a has selected District C.

Subsequently, a vector, β(β_{A,tran}, β_{A,neig}), of likings of Subject a is adjusted such that the probability that District C is selected becomes the highest. Specifically, a score given by Subject a to each of the districts is calculated by Equation (3), where (β_{A,tran})=1 and (β_{A,neig})=1. Here, Score_{a,A}=1·30+1·40=50=VaA, Score_{a,B}=1·20+1·40=60=VaB, and Score_{a,C}=1·10+1·30=40=VaC.

A probability (Pac) that Subject a will select District C is calculated, by use of a logit model, as Pac=Score of District C/Total of respective scores=e^{VaC}/(e^{VaA}+e^{VaB}+e^{VaC}). Since Pac is a function of the vector, β(β_{A,tran}, β_{A,neig}) of the likings of Subject a, the vector, β(β_{A,tran}, β_{A,neig}), that maximizes Pac is able to be calculated as “arg max_{β}(β_{A,tran}, ρ_{A,neig})”. A value calculated thereby is a value of β that matches selection of Subject a the most (maximum likelihood method).

In order to converge “arg max_{β}(β_{A,tran}, β_{A,neig})”, the value is converged by the questionnaire being implemented with respect to dozens of people in the same segment, and a vector β being derived so as to maximize the sum of probabilities output as a result of the implementation of the questionnaire. When that is done, people in the same segment are assumed to have the same preferences (vector β), and calculation is performed as if average preferences of the group have been selected by a single user.

Processing Method

The above described embodiment has been described with the example, in which the processing of execution of resegmentation is executed after the processing of search for preferences of a user in the same segment, but not being limited thereto, any one these may be executed.

Hardware

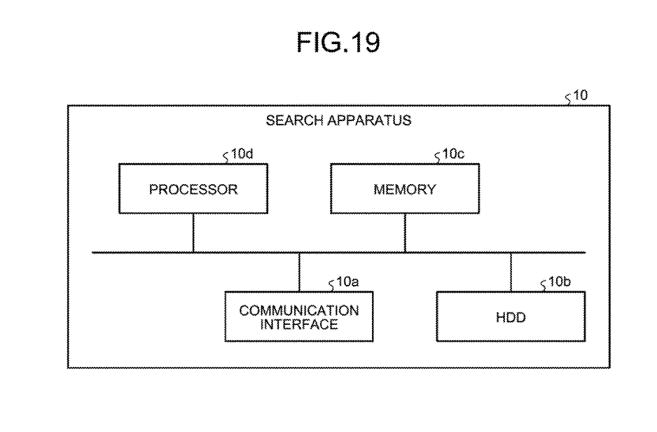

FIG. 19 is a diagram illustrating an example of a hardware configuration. As illustrated in FIG. 19, the search apparatus 10 has a communication interface 10a, a hard disk drive (HDD) 10b, a memory 10c, and a processor 10d. Further, these units illustrated in FIG. 19 are connected to one another via a bus or the like.

The communication interface 10a is a network interface card, or the like, and executes communication with another server. The HDD 10b stores therein a program that causes the functions illustrated in FIG. 2 to operate, and the DBs.

The processor 10d causes a process, which executes the respective functions described with respect to FIG. 2 and the like, to operate, by reading out and expanding a program that executes processing that is the same as that of the respective processing units illustrated in FIG. 2, from the HDD 10b or the like, into the memory 10c. That is, this process executes functions that are the same as those of the respective processing units that the search apparatus 10 has. Specifically, the processor 10d reads out a program having functions that are the same as those of the preference search unit 20, the attribute search unit 30, and the like, from the HDD 10b or the like. The processor 10d executes a process that executes processing that is the same as that of the preference search unit 20, the attribute search unit 30, and the like.

As described above, the search apparatus 10 operates as an information processing apparatus that executes a search method, by reading out and executing the program. Further, by reading out the program from a recording medium through a medium reading device and executing the program read out, the search apparatus 10 may realize functions that are the same as those of the above described embodiment. In addition, the program referred to in this other embodiment is not limited to being executed by the search apparatus 10. For example, the present invention is similarly applicable to a case where another computer or a server executes the program, or a case where this computer and this server execute the program in cooperation with each other.

System

Of the processing described in the embodiments, all or a part of any processing described as being executed automatically may be executed manually. Or, all or a part of any processing described as being executed manually may be executed automatically by a known method. In addition, the sequences of the processing, the control sequences, the specific names, and the information including the various data and parameters described above and illustrated in the drawings may be arbitrarily modified unless otherwise particularly stated.

Further, each component of the respective devices in the drawings has been functionally and conceptionally illustrated, and is not always configured physically as illustrated in the drawings. That is, specific modes of separation and integration of the respective devices are not limited to those illustrated in the drawings. That is, all or a part of the devices may be configured to be functionally or physically separated or integrated in arbitrary units depending on various loads, use situations, and the like. Further, all or any part of each processing function performed in each device may be realized by a CPU and a program analyzed and executed by the CPU, or realized as hardware by wired logic.

According to the embodiments, preferences of a respondent are able to be specified appropriately.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a searching program that causes a computer to execute a process comprising:
specifying a first respondent group based on a respondent attribute of a respondent;
searching for a respondent preference of the respondent utilizing a plurality of inquiries for the respondent, the plurality of inquiries being made with a first preference of the first respondent group as an initial value and corresponding to a first segment that the first respondent group belongs to;
when a specific condition is not satisfied after search from the initial value with a specific number of inquiries, generating or selecting a second respondents group based on the respondent attribute, answers to the plurality of inquiries, and on preferences of a second respondent group, the second respondent group satisfying the specific condition; and
searching for the respondent preference with a preference of the second respondent group being an initial value.

2. The non-transitory computer-readable recording medium according to claim 1, wherein the process further comprises:
classifying the respondent into a first segment that the first respondent group having the attribute in common belongs to;
setting an average value of feature quantities specified from preferences of the first respondent group as an initial value of the respondent;
executing inquiry based on the initial value of the respondent, and calculating a feature value of the respondent according to an answer to the inquiry;
setting a feature value of another respondent from the first respondent group, the feature value similar to the feature value of the respondent, as a feature value of the respondent; and
executing inquiry based on the set feature value of the respondent and searching for the respondent preference.

3. The non-transitory computer-readable recording medium according to claim 2, wherein the process further comprises:
when the specific condition is not satisfied after a specific number of inquiries based on the feature value of the respondent has been executed, classifying another respondent group into plural segments again by using an attribute different from the attribute;
executing inquiry related to an attribute with respect to the respondent, specifying a second segment that the respondent belongs to, the second segment being of the plural segments resulting from the classification executed again, and classifying the respondent into the second segment;
setting an average value of feature values specified from preferences of the second respondent group belonging to the second segment as an initial value of the respondent; and
executing inquiry based on the initial value of the respondent and searching for the respondent preference.

4. The non-transitory computer-readable recording medium according to claim 3, wherein the process further comprises:
when the specific condition is not satisfied as a result of the inquiry corresponding to the second segment, calculating a feature value of the respondent according to an answer to the inquiry;
specifying another respondent of the second group of respondents, the another respondent having a feature value similar to the feature value of the respondent, and setting the feature value of the another respondent as a feature value of the respondent; and
executing inquiry based on the set feature value of the respondent and searching for the respondent preference.

5. The non-transitory computer-readable recording medium according to claim 2, wherein the calculating includes executing the inquiry causing a preference considered by the respondent to be important to be selected, and calculating the feature value of the respondent such that a weight of the preference considered by the respondent to be important is increased.

6. A search method comprising:
specifying a first respondent group based on a respondent attribute of a respondent, using a processor;
searching for a respondent preference of the respondent utilizing a plurality of inquiries for the respondent, the plurality of inquiries being made with a first preference of the first respondent group as an initial value and corresponding to a first segment that the first respondent group belongs to, using the processor;
when a specific condition is not satisfied after search from the initial value with a specific number of inquiries, generating or selecting a second respondents group based on the respondent attribute, answers to the plurality of inquiries, and on preferences of a second respondent group, the second respondent group satisfying the specific condition, using the processor; and
searching for the respondent preference with a preference of the second respondent group being an initial value, using the processor.

7. A search apparatus comprising:
a processor configured to:
specify a first respondent group based on a respondent attribute of a respondent;
search for a respondent preference of the respondent utilizing a plurality of inquiries for the respondent, the plurality of inquiries being made with a first preference of the first respondent group as an initial value and corresponding to a first segment that the first respondent group belongs to;
when a specific condition is not satisfied after search from the initial value with a specific number of inquiries, generate or selecte a second respondents group based on the respondent attribute, answers to the plurality of inquiries, and on preferences of a second respondent group, the second respondent group satisfying the specific condition; and
searche for the respondent preference with a preference of the second respondent group being an initial value.
